(19) United States
(12) Patent Application Publication
(10) Pub. No.: US 2008/0011325 A1
(43) Pub. Date: Jan. 17, 2008

(54) METHODS AND APPARATUS FOR SUPPORTING A SUBSTRATE IN A HORIZONTAL ORIENTATION DURING CLEANING

(76) Inventors: Donald J.K. Olgado, Palo Alto, CA (US); Roy C. Nangoy, Santa Clara, CA (US); Shesraj L. Tulshibagwale, Santa Clara, CA (US); Hui Chen, Burlingame, CA (US); Ho Seon Shin, Cupertino, CA (US)

Correspondence Address: DUGAN & DUGAN, PC, 55 SOUTH BROADWAY, TARRYTOWN, NY, 10591, US

(21) Appl. No.: 11/757,850

(22) Filed: Jun. 4, 2007

Related U.S. Application Data
(60) Provisional application No. 60/811,161, filed on Jun. 5, 2006.

(51) Int. Cl. B08B 7/04; A46B 13/00; B24B 51/00; B08B 3/10

(52) U.S. Cl. 134/9; 134/43; 15/21.1

(57) ABSTRACT

In one or more aspects, an apparatus for cleaning a substrate includes (1) a plurality of rollers adapted to contact and support the substrate in a horizontal orientation, and (2) at least one brush adapted to contact a major surface of the substrate while the substrate is supported by the plurality of rollers to clean the major surface of the substrate. At least one of the plurality of rollers is adapted to move between an opened position allowing the substrate to be loaded onto or unloaded from the plurality of rollers and a closed position in which the substrate is supported by the plurality of rollers. Numerous other aspects are provided.

The present application claims priority to U.S. Provisional Application Ser. No. 60/811,161, filed Jun. 5, 2006, which is hereby incorporated by reference herein in its entirety for all purposes.

### FIELD OF THE INVENTION

The present invention relates to semiconductor device fabrication, and more particularly to methods and apparatus for cleaning a substrate.

### BACKGROUND OF THE INVENTION

Known devices, sometimes referred to as scrubbers, are often employed to clean semiconductor substrates at one or more stages of an electronic device manufacturing process. For example, a scrubber may be employed to clean a substrate after chemical mechanical polishing (CMP) of the substrate. Known scrubbers employ one or more scrubber brushes that are rotated while in contact with the substrate to thereby clean the substrate.

While a number of scrubber systems exist in the art, a need remains for improved scrubber designs.

### SUMMARY OF THE INVENTION

In some aspects of the invention, an apparatus for cleaning a substrate is provided that includes (1) a plurality of rollers adapted to contact and support the substrate in a horizontal orientation, and (2) at least one brush adapted to contact a major surface of the substrate while the substrate is supported by the plurality of rollers so as to clean the major surface of the substrate, wherein at least one of the plurality of rollers is adapted to move between an opened position that allows the substrate to be loaded onto or unloaded from the plurality of rollers and a closed position in which the substrate is supported by the plurality of rollers.

In some other aspects of the invention, a method of cleaning a substrate is provided that includes supporting the substrate in a horizontal position via a plurality of rollers and contacting at least one major surface of the substrate with a brush while the substrate is supported in the horizontal position so as to clean the major surface of the substrate.

Other features and aspects of the present invention will become more fully apparent from the following detailed description, the appended claims and the accompanying drawings.

### BRIEF DESCRIPTION OF THE DRAWINGS

FIG. 1A is a schematic top view of a first exemplary substrate cleaning apparatus provided in accordance with an embodiment of the present invention.

FIG. 1B is a schematic top view of the first exemplary substrate cleaning apparatus depicting a roller in an opened position in accordance with an embodiment of the present invention.

FIG. 2 is a perspective view of a second exemplary substrate cleaning apparatus provided in accordance with another embodiment of the present invention.

FIG. 3 is a top view of the second exemplary substrate cleaning apparatus in accordance with an embodiment of the present invention.

FIG. 4A is a perspective view of the second exemplary substrate cleaning apparatus in an opened position in accordance with an embodiment of the present invention.

FIG. 4B is a perspective view of the second exemplary substrate cleaning apparatus in a closed position in accordance with an embodiment of the present invention.

FIG. 5A is a top view of the second exemplary substrate cleaning apparatus in an opened position in accordance with an embodiment of the present invention.

FIG. 5B is a top view of the second exemplary substrate cleaning apparatus in a closed position in accordance with an embodiment of the present invention.

FIG. 6 is a front perspective view of a third exemplary substrate cleaning apparatus provided in accordance with another embodiment of the present invention.

FIG. 7 is a side perspective view of the third exemplary substrate cleaning apparatus in accordance with an embodiment of the present invention.

FIG. 8 is a side elevation view of the third exemplary substrate cleaning apparatus in accordance with an embodiment of the present invention.

FIG. 9A is a bottom view of the third exemplary substrate cleaning apparatus in accordance with an embodiment of the present invention.

FIG. 9B is a schematic perspective view of an exemplary lift pin provided in accordance with an embodiment of the present invention.

FIG. 10 is a top view of the third exemplary substrate cleaning apparatus in accordance with an embodiment of the present invention.

### DETAILED DESCRIPTION

In accordance with the present invention, a plurality of rollers may support and rotate a substrate in a horizontal orientation. Additionally, a brush may be in contact with the substrate while the substrate is rotating to clean a surface of the substrate. Additionally or alternatively, a fluid spray may be employed to clean the surface of the substrate. In some embodiments of the invention, a roller may move between a closed position and an opened position. In the closed position, the plurality of rollers support the substrate in a horizontal orientation. In the opened position, the substrate may be loaded onto or unloaded from the plurality of rollers.

Cleaning and brushing of substrates in a horizontal orientation allows for convenient and rapid transfer of substrates into and out cleaning tools. Moreover, it has been found that horizontal brushing provides a uniform distribution of cleaning fluid over substrates. The horizontal design may also be used to accommodate additional processing such as bevel polishing or cleaning in which substrates are similarly processed while in a horizontal orientation.

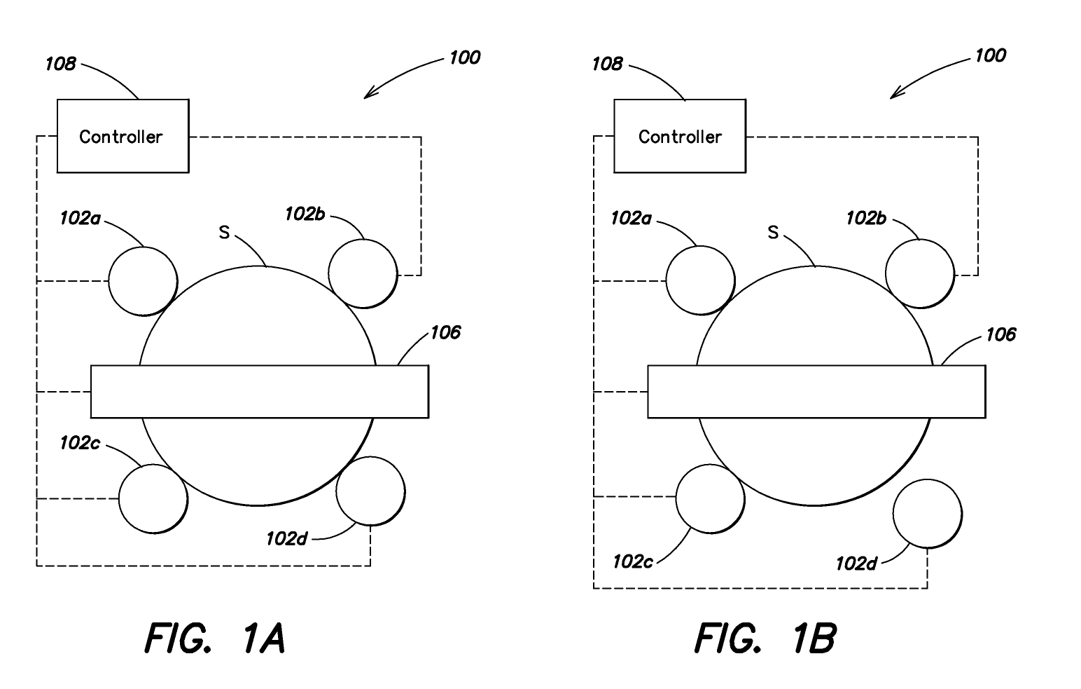

FIGS. 1A and 1B illustrate top views of a first exemplary substrate cleaning apparatus 100 provided in accordance with the present invention in a closed and an opened position, respectively. With reference to FIGS. 1A-1B, the first apparatus 100 includes a plurality of rollers 102a-d adapted to support and rotate a substrate S in a horizontal orientation. The first apparatus 100 may also include a brush 106 or another suitable device for cleaning a major surface of the substrate S.

With reference to FIGS. 1A-1B, the first apparatus 100 includes at least one roller 102d adapted to move between the opened position (FIG. 1B) and the closed position (FIG. 1A). When the roller 102d is in the opened position the substrate S may be loaded or unloaded from the rollers 102a-d. The rollers 102a-d may hold and support the substrate S in the closed position when the roller 102d is in the closed position. A controller 108 may direct the brush 106 and the rollers 102a-d to rotate to clean the substrate S. The controller 108 may also direct the roller 102d to move between the opened and closed positions. The controller 108 may be, for example, one or more microprocessors or microcontrollers, dedicated hardware, a combination of the same, etc.

The rollers 102a-d may be made of any material suitable for holding and rotating the substrate S. For example, the rollers may be made of rubber or another like material.

The rollers 102a-d may be any suitable shape or size. For example, although rollers 102a-d of the same dimensions are illustrated in FIGS. 1A and 1B, rollers of different dimensions may be employed. Also, although four rollers 102a-d are shown in FIGS. 1A-1B, it will be understood that fewer or more rollers may be used. In at least one embodiment, the rollers 102a-b may be driven rollers and the rollers 102c-d may be non-driven or “idler” rollers, although other configurations may be used. A same or different motor may be used to drive each driven roller.

Each roller 102a-d may include a groove (not shown) in the surface of the roller 102a-d. The groove may be, for example, a continuous v-shaped or u-shaped valley along the circumference of each of the rollers 102a-d. When the roller 102d is in the closed position, an edge of the substrate S will be positioned in the groove of each roller 102a-d. One or more of the rollers 102a-d may also include treads or other similar surface features that allow fluid to drain from the substrate/roller interface so as to improve the holding and rotating of the substrate S by the rollers 102a-d.

The brush 106 may be any suitable brush for cleaning the major surface of the substrate S. For example, the brush 106 may be a polyvinyl acetate (PVA) brush or a brush made from other porous or sponge-like material with a smooth surface or raised features (e.g., nodules) that may be employed to clean the major surface of the substrate S. The substrate S may rotate (e.g., via the rollers 102a-d) while the brush 106 is in contact with the major surface of the substrate S. Although a single cylindrical brush 106 is shown in FIG. 1, it is understood that more than one brush 106 and/or any suitable shapes may be employed, such as a brush positioned to clean a backside of the substrate S. It is noted that the rotation of the substrate S and rotation of the brush 106 may be independent of one another.

In operation, the rollers 102a-d may be employed to hold and rotate the substrate S. For example, at least one of the rollers 102a-d may impart rotation to the substrate S via one or more motors. One of the rollers 102a-d may be adapted to function as an idler for measuring the rotation of the substrate S. To hold the substrate S, the roller 102d may move from an opened position (shown in FIG. 1B) to a closed position (shown in FIG. 1A). It is understood that more than one of the rollers 102a-d may be adapted to move between the opened and closed positions.

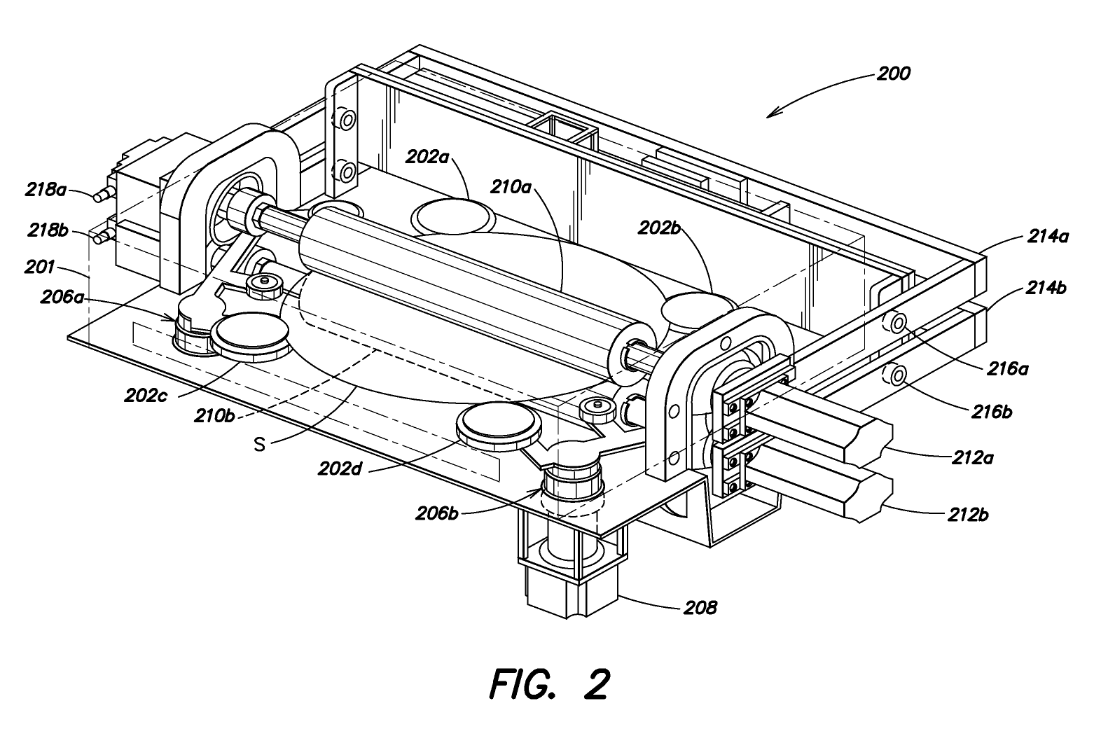

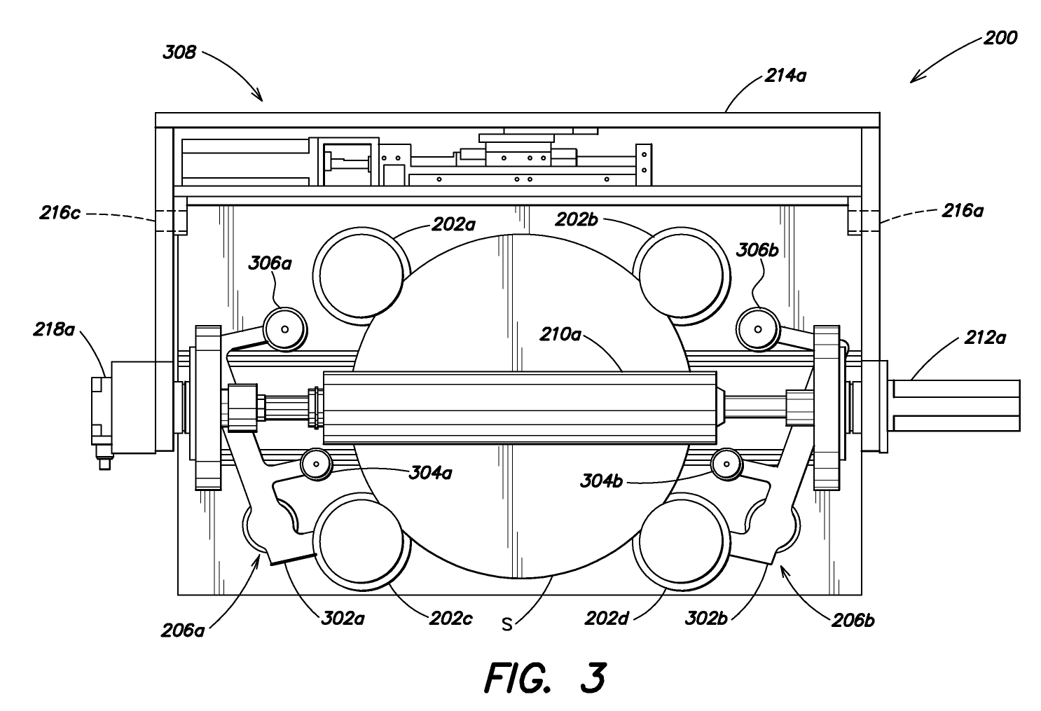

FIG. 2 illustrates a perspective view of a second exemplary substrate cleaning apparatus 200 provided in accordance with an embodiment of the present invention. With reference to FIG. 2, the second apparatus 200 includes a housing 201 and rollers 202a-d that may be similar to the rollers 102a-d of the first embodiment 100 of FIGS. 1A-1B. The rollers 202c-d may be coupled to rotation axes 206a-b to pivot the rollers 202c-d from an opened and a closed position similar to the apparatus 100. Such coupling and pivoting of the rollers 202c-d will be described below in more detail with reference to FIG. 3. A motor 208 may be coupled to the rotation axes 206a-b and employed to pivot the rollers 202c and 202d.

The apparatus 200 may also include an upper and lower brush 210a-b, which may be similar to the brush 106 of the first apparatus 100 of FIGS. 1A-1B. The upper and lower brushes 210a-b may be coupled to upper and lower brush motors 212a-b, respectively. The upper and lower brushes 210a-b and the upper and lower brush motors 212a-b may be coupled to upper and lower swing arms 214a-b, respectively. The upper and lower swing arms 214a-b may be rotatably coupled to upper and lower bearings 216a-d (only 216a-b are shown in FIG. 2).

Although a single motor 208 is employed, a plurality of motors 208 may be employed in the same or alternative embodiments. It is also understood that more or fewer brush motors 212a-b may be employed.

To allow the substrate S to be loaded and unloaded from the rollers 202a-d, the upper and lower brushes 210a-b may be adapted to move between a non-contact position and a contact position. In the contact position, the brushes 210a-b may contact and/or clean the major surfaces of the substrate S. The mechanism employed to move and press the brushes 210a-b into the major surfaces of the substrate S is described in more detail below with reference to FIG. 3.

Fluid couplers 218a-b may be provided for supplying fluid to the upper and lower brushes 210a-b, respectively. For example, the fluid couplers 218a-b may be adapted to supply cleaning fluid or another suitable fluid from a fluid source to the upper and lower brushes 210a-b. Accordingly, the upper and lower brushes 210a-b may apply fluid to the major surfaces of the substrate S. The fluid may be any suitable fluid (e.g., cleaning solution, DI water, etc.) for cleaning the major surfaces of the substrate S.

FIG. 3 illustrates a top view of the second exemplary substrate cleaning apparatus 200. With reference to FIG. 3, as discussed above with reference to FIG. 2, the rollers 202a-d may hold and rotate the substrate S in a horizontal orientation. Arms 302a-b may be coupled to the rotation axes 206a-b, respectively, and rotate with the rotation axes 206a-b. Front pads 304a-b and back pads 306a-b may be coupled to the arms 302a-b, respectively, for supporting substrates during load/unload operations as described below. As further shown in FIG. 3, a brush actuator 308 may be coupled to the brush arms 214a-b for moving the brush arms 214a-b together or apart, which then causes the brushes 210a-b to move reciprocally apart or together (as described below). As shown in FIG. 3, the arms 302a-b are L-shaped and the front pads 304a-b and the back pads 306a-b are circular, although any suitable shapes may be employed.

As shown in FIG. 3, the arms 302a-b are in the closed position. In the closed position, all of the rollers 202a-d are in contact with the substrate S. In such a position, the rollers 202a-d may support and/or rotate the substrate S in a horizontal orientation, as described with reference to FIG. 2. As shown, the front pads 304a-b and the back pads 306a-b may not be in contact with the substrate S when the rollers 202c-d are in the closed position.

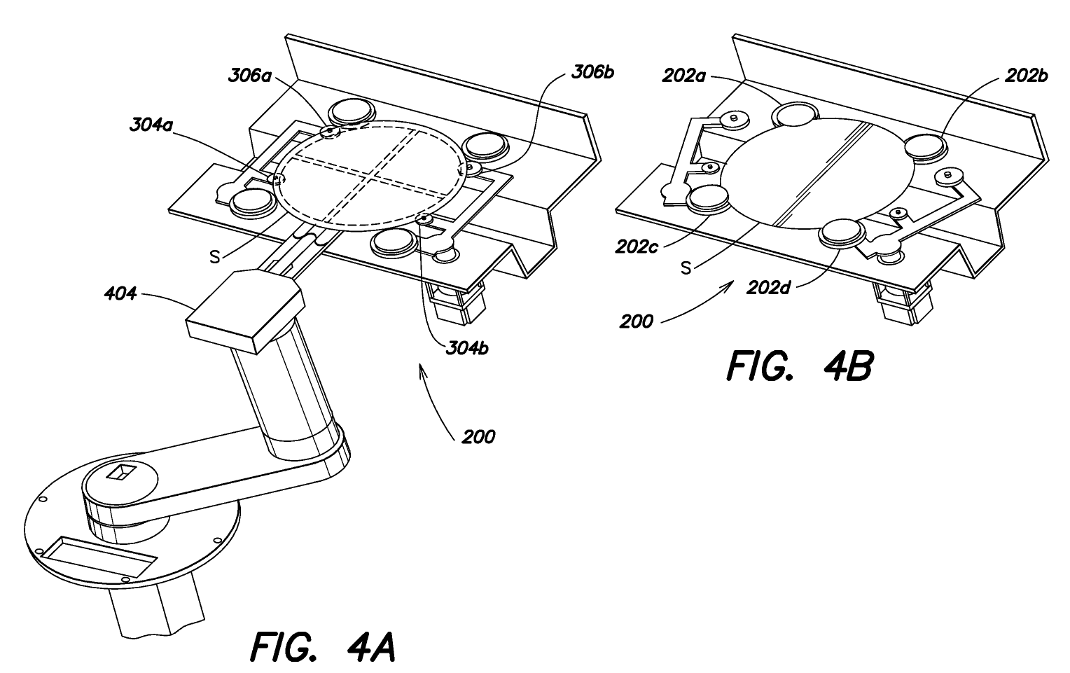

In the opened position, the front pads 304a-b and the back pads 306a-b may contact the bottom major surface of the substrate S. This position is described in more detail below with reference to FIG. 4A.

The brush actuator 308 may be employed to press the brushes 210a-b into the major surfaces of the substrate S. The brush actuator 308 may be adapted to move the brush arms 214a-b between a brush opened position and a brush closed position. Specifically, the brush actuator 308 may adapted to apply a force to the brush arms 214a-b so as to spread the brush arms 214a-b apart where the brush actuator 308 is coupled to the brush arms 214a-b. In response, the brush arms 214a-b pivot about the bearings 216a-d to press the brushes 210a-b into the major surfaces of the substrate S.

FIGS. 4A and 4B illustrate perspective views of the second exemplary substrate cleaning apparatus 200 in opened and closed positions, respectively. With reference to FIG. 4A, the second apparatus 200 is depicted in an opened position with substrate S being removed or inserted by a robot 404. When the robot 404 releases the substrate S, the front pads 304a-b, and the back pads 306a-b support the substrate S. While the substrate S is supported by the pads 304a-b and 306a-b, the robot 404 may withdraw from the second apparatus 200.

With reference to FIG. 4B, the second apparatus 200 is shown in a closed position with the rollers 202a-d holding and rotating the substrate S in a manner similar to that described with reference to FIGS. 2-3.

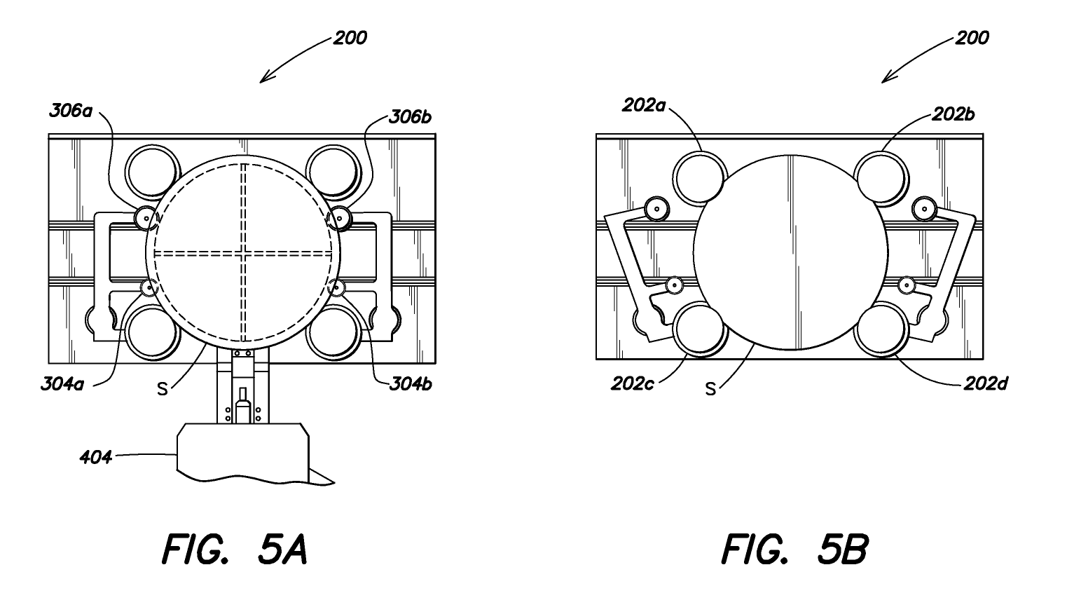

FIGS. 5A and 5B illustrate top views of the second exemplary substrate cleaning apparatus 200 in opened and closed positions, respectively. With reference to FIG. 5A, the second apparatus 200 is depicted in an opened position with the robot 404 loading or unloading substrate S, as described above with reference to FIG. 4A. The substrate S covers a portion of the front pads 304a-b and the back pads 306a-b. With reference to FIG. 5B, the second apparatus 200 is depicted in a closed position, as described above with reference to FIG. 4B.

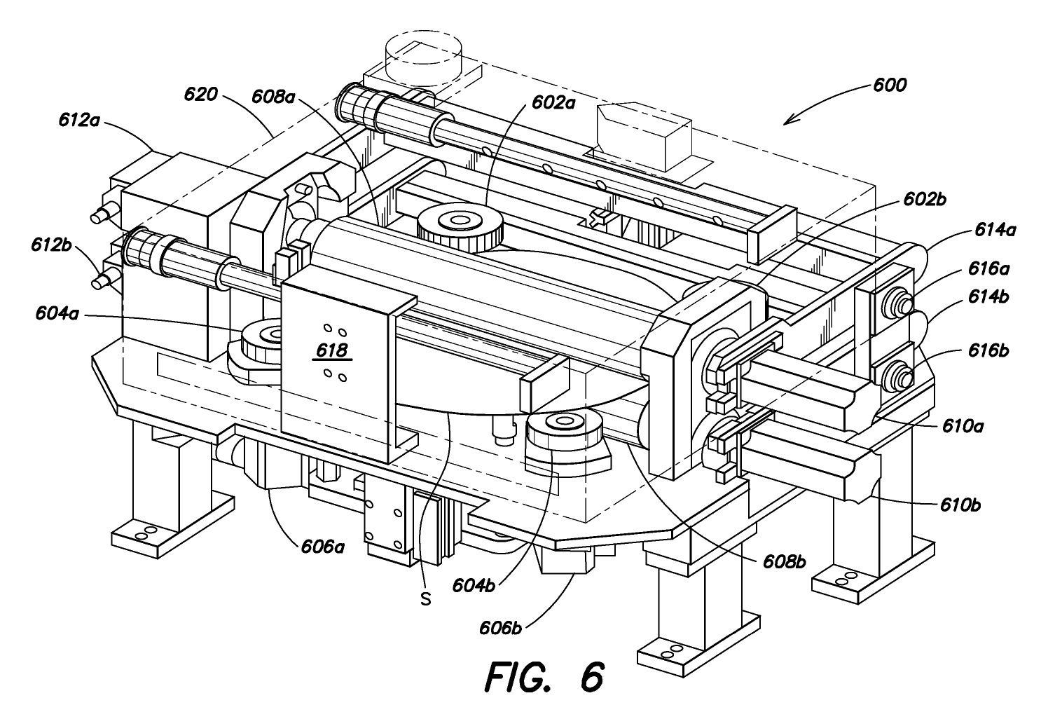

FIG. 6 illustrates a front perspective view of a third exemplary substrate cleaning apparatus 600 as provided according to an embodiment of the present invention. With reference to FIG. 6, drive rollers 602a-b and idle rollers 604a-b may hold and rotate the substrate S in a horizontal orientation. The drive rollers 602a-b and the idle rollers 604a-b may be similar to the rollers 102a-d and the rollers 202a-d. More specifically, the drive rollers 602a-b and the idle rollers 604a-b may have similar materials, dimensions, etc. as the rollers 102a-d and 202a-d. The idle rollers 604a-b may be coupled to linear actuators 606a-b, respectively.

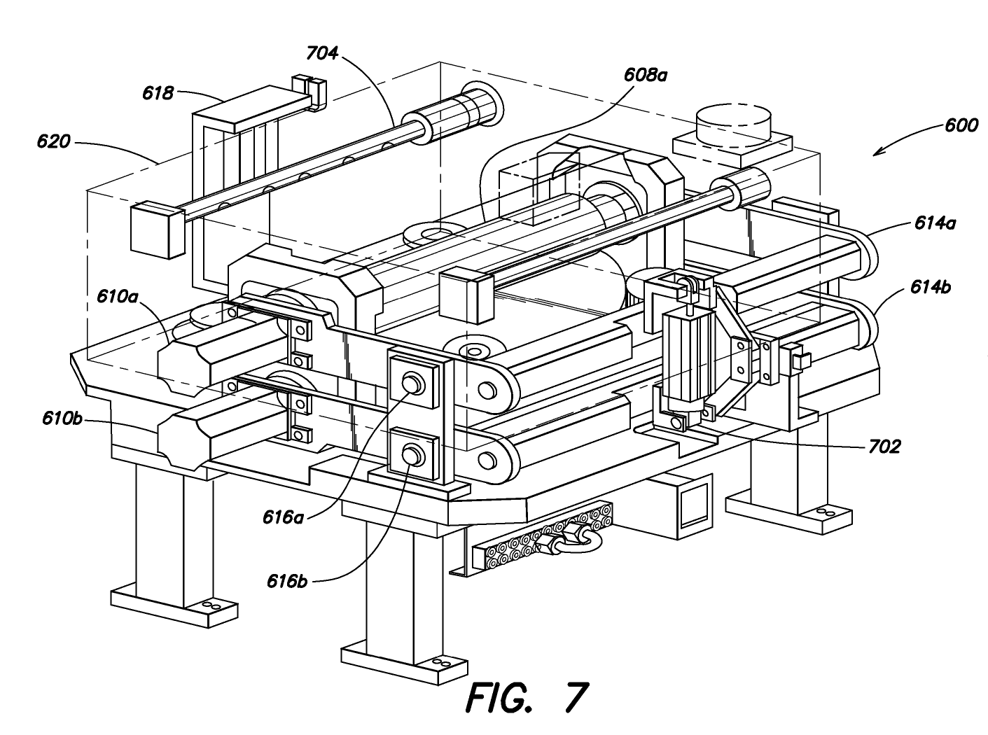

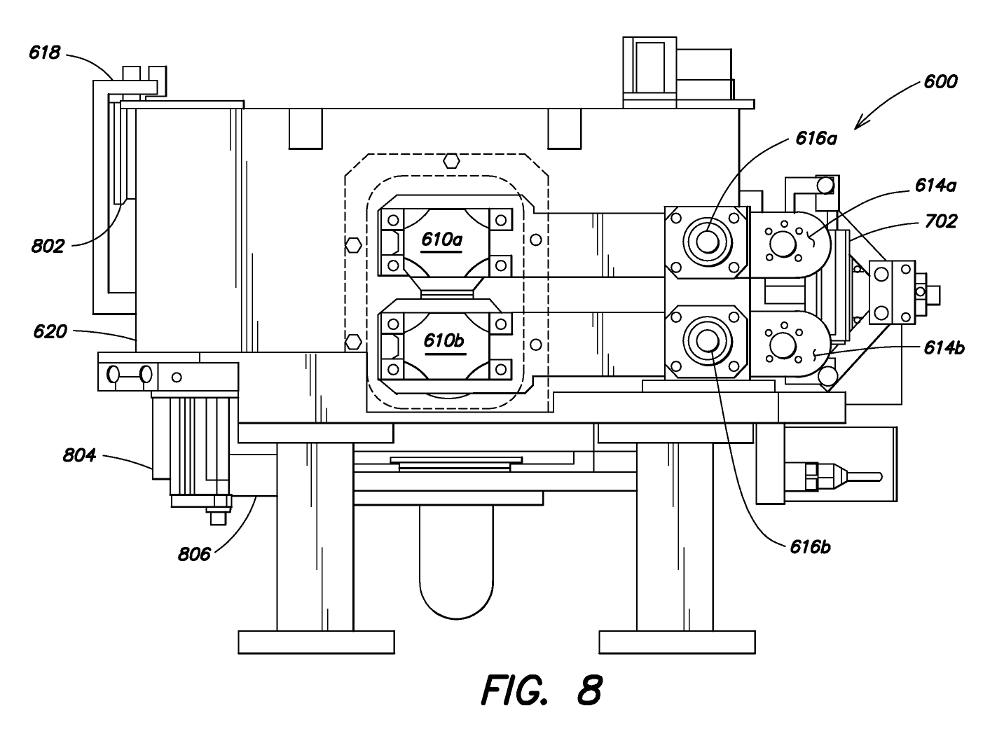

Still with reference to FIG. 6, upper and lower substrate brushes 608a-b may also contact the major surfaces of the substrate S, as will be described in more detail below with reference to FIG. 7. The brushes 608a-b may be coupled to upper and lower brush drive motors 610a-b, as well as to the upper and lower brush fluid couplers 612a-b, respectively. The motors 610a-b may also be coupled to the upper and lower arms 614a-b, respectively, which are rotatably coupled to the bearings 616a-d (only 616a,b are shown). A gate 618 may be coupled to a housing 620 (shown in phantom) and adapted to move between a gate opened position and a gate closed position (as described below).

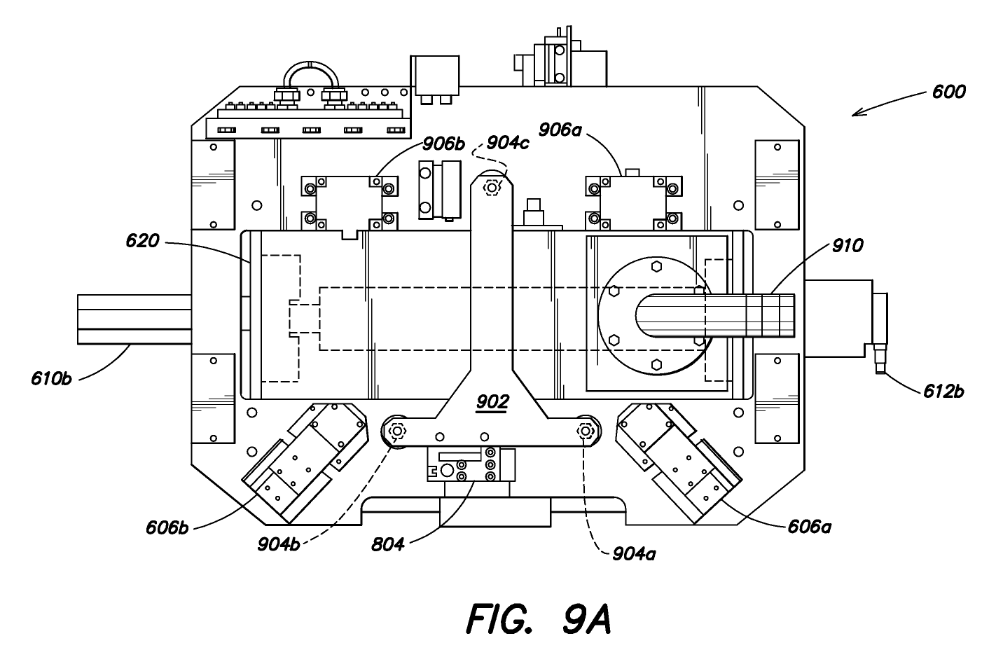

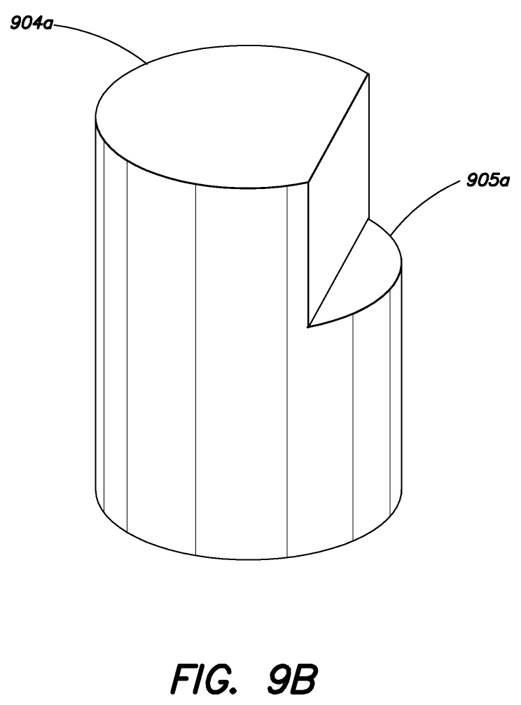

The idle rollers 604a-b may be adapted to move linearly between an opened position and a closed position. The closed position is depicted in FIG. 6. The opened position allows the substrate S to be loaded onto or unloaded from the rollers 602a-b and 604a-b. In the closed position, the idle rollers 604a-b may press the substrate S into the drive rollers 602a-b. Accordingly, the drive rollers 602a-b and the idle rollers 604a-b may hold and rotate the substrate S in a horizontal orientation. One or more motors may rotate the drive rollers 602a-b so as to rotate the substrate S as described below in more detail with reference to FIG. 9A.

The idle rollers 604a-b may be any suitable roller that freely rotates with the substrate S. Further, the idle rollers 604a-b may be adapted to measure the rotation speed of the substrate S.

The linear actuators 606a-b may be any suitable mechanism for moving the idle rollers 604a-b between the opened and closed positions. For example, the linear actuators 606a-b may be pneumatic actuators. Although, the motion is depicted as linear, it is understood that in alternative embodiments of the present invention, the motion may follow a path that is not linear. For example, the motion may be a combination of the linear path and the pivot path as described above with reference to FIGS. 2-5.

The brushes 608a-b may be any suitable brushes for cleaning the major surfaces of the substrate S. For example, the brushes 608a-b may have materials, dimensions, etc., similar to the brushes 210a-b.

The fluid couplers 612a-b may be similar to the upper and lower fluid couplers 218a-b, although any suitable device for coupling a fluid supply to brushes 608a-b may be used. For example, the couplers 612a-b may supply fluid to the brushes 608a-b, and the brushes 608a-b may apply such fluid to the major surfaces of the substrate S.

The arms 614a-b may be similar to the upper and lower arms 214a-b, respectively, as described with reference to FIGS. 2-3. Similarly, the bearings 616a-d may be similar to the upper and lower bearings 216a-d described with reference to FIGS. 2-3. The arms 614a-b may be adapted to rotate about the bearings 616a-d.

As shown in FIG. 6, the gate 618 may be adapted to lift or lower between the gate opened and the gate closed positions. When the gate 618 is in the gate opened position, the substrate S may be removed from or inserted into the third apparatus 600. In the gate closed position, the gate 618 may seal or cover the internal region of the third apparatus 600. It is understood that in the same or alternative embodiments, the gate 618 may be reversed so as to lower into the gate opened position. A mechanism to move the gate 618 between the gate opened and the gate closed positions is described below in more detail with reference to FIG. 8.

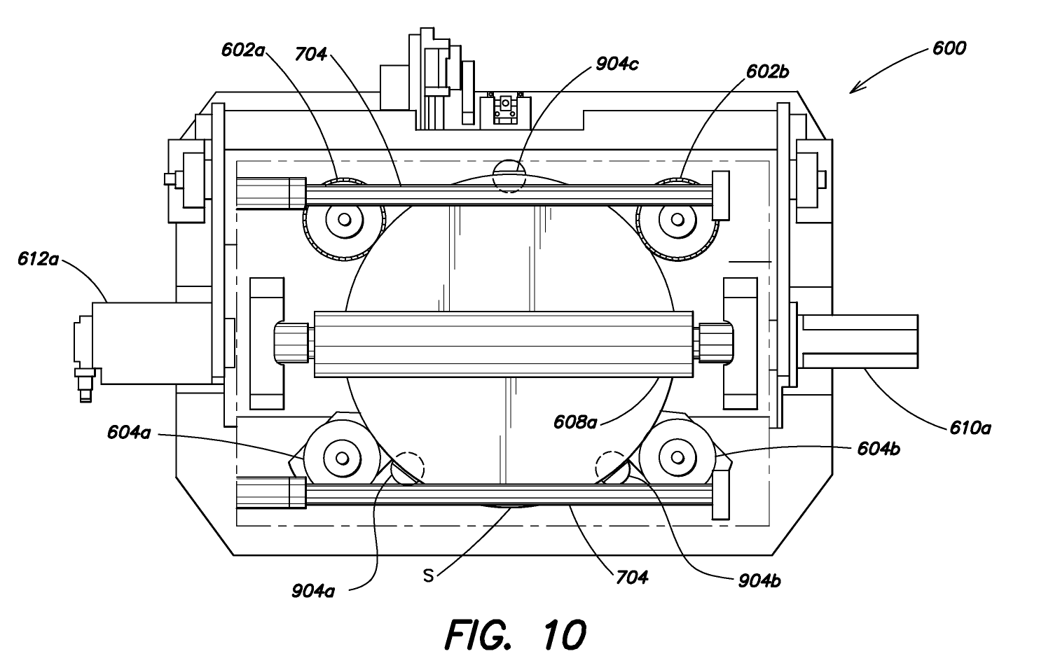

In operation, the substrate S may be loaded or unloaded from the rollers 602a-b and 604a-b by a robot (not shown) similar to the robot 404 shown in FIGS. 4-5, although any suitable robot may be employed. When the substrate S is placed into the third apparatus 600, the substrate S may be positioned in a predetermined location in the vertical direction as will be described below in more detail with reference to FIGS. 9-10. Once the substrate S is positioned, the linear actuators 606a-b may move the idle rollers 604a-b to the closed position so as to hold the substrate S against the drive rollers 602a-b. Subsequently, the drive rollers 602a-b may rotate the substrate S. The rotation of the drive rollers 602a-b is described below in more detail with reference to FIG. 9A.

While the substrate S is being loaded or unloaded from the rollers 602a-b and 604a-b, the brushes 608a-b may be in the opened position. The brushes 608a-b may move between the opened position and the closed position, as will be described below with reference to FIG. 7, to apply pressure to the major surfaces of the substrate S. Such pressure may improve the cleaning of the major surfaces of the substrate S.

The motors 610a-b may rotate the brushes 608a-b, respectively, so that the brushes 608a-b may clean the major surfaces of the substrate S by rotating while in contact with the substrate S. Additionally, the fluid couplers 612a-b may supply the fluid to the brushes 608a-b. The fluid may flow through the body of the brushes 608a-b onto the major surfaces of the substrate S. Such fluid may improve the cleaning of the major surfaces of the substrate S.

FIG. 7 illustrates a side perspective view of the third exemplary substrate cleaning apparatus 600 as provided according to an embodiment of the present invention. With reference to FIG. 7, a brush actuator 702 may be coupled to the arms 614a-b. The brush actuator 702 may be adapted to move the brushes 608a-b by applying a force to the arms 614a-b. The brush actuator 702 may be a pneumatic actuator or another device suitable for applying a force to the arms 614a-b. Although one brush actuator 702 is shown in FIG. 7, more than one may be used. In alternative embodiments, the brush actuator 702 may be oriented in different directions. For example, the brush actuator 702 may be oriented horizontally with a mechanism that is adapted to convert a horizontal force into a vertical force (e.g., wedge, cam, etc.).

As stated, the brush actuator 702 may apply a force to the arms 614a-b. For example, the brush actuator 702 may spread apart the arms 614a-b and cause the arms 614a-b to rotate about the bearings 616a-d so as to press the brushes 608a-b into the major surfaces of the substrate S. Conversely, the brush actuator 702 may pull the arms 614a-b closer together so as to reduce the pressure applied by the brushes 608a-b or pull the brushes 608a-b away from the major surfaces of the substrate S.

A spray tube 704 may be coupled to the housing 620, and adapted to supply fluid to the substrate S (e.g., rinsing fluid, cleaning fluid, sonically energized fluid, etc.).

FIG. 8 illustrates a side view of the third substrate cleaning apparatus 600 as provided according to an embodiment of the present invention. With reference to FIG. 8, a gate actuator 802 may be coupled to the gate 618 and the housing 620, and a lift actuator 804 may be coupled to the housing 620 and a lift arm 806. The lift actuator 804 and the lift arm 806 may be employed to lift the substrate S as described below with reference to FIG. 9A.

The gate actuator 802 may be any suitable mechanism for applying a force to the gate 618. Similarly, the lift actuator 804 may be any suitable mechanism for applying a force to the lift arm 806. For example, the gate actuator 802 or the lift actuator 804 may be a pneumatic actuator coupled to a supply of pressurized air. Accordingly, the gate actuator 802 or the lift actuator 804 may use the pressurized air to apply a force. Alternatively, the gate actuator 802 or the lift actuator 804 may be a motor (e.g., electric, stepper, etc.)

The gate actuator 802 may apply a force to raise or lower the gate 618. Such a motion is described above with reference to FIG. 7. Although a single gate actuator 802 is shown in FIG. 8, more than one gate actuator 802 may be employed. For example, two gate actuators 802 may be employed to raise and lower the gate 618. In alternative embodiments, the gate actuator 802 may be oriented in different directions. For example, the gate actuator 802 may be oriented horizontally so as to apply a force perpendicular to the motion of the gate 618. A mechanism may be adapted to convert the horizontal force into a vertical force (e.g., wedge, cam, etc.) that may be applied to the gate 618.

The lift actuator 804 may be employed to move the lift arm 806 between a lifted and a lowered position. Similar to the gate actuator 802, alternative quantities and/or orientations of lift actuator 804 may be employed to move the lift arm 806. The mechanism employed to move the substrate S with the lift arm 806 is described below in more detail with reference to FIG. 9A.

FIG. 9A illustrates a bottom view of the third exemplary substrate cleaning apparatus 600 as provided according to an embodiment of the present invention. With reference to FIG. 9A, a lift arm comprising a lift plate 902 coupled to lift pins 904a-c is shown coupled to the lift actuator 804. Drive motors 906a-b for driving the drive rollers 602a-b, respectively, are also shown.

The lift plate 902 is adapted to lift and lower lift pins 904a-c so as to raise and lower the substrate S relative to the rollers 602a-b, 604a-b as described below. The lift plate 902 may be made of any suitable material. For example, the lift plate 902 may be a piece of aluminum, plastic or another suitable material. Although a T-shape is shown in FIG. 9A, other shapes may be employed. For example, a delta-shape may be employed.

The pins 904a-c may comprise pieces of metal or another suitable material. For example, the pins 904a-c may be anodized aluminum pins that are adapted to couple to the lift plate 902 and contact a portion of the substrate S.

A schematic perspective view of an exemplary lift pin 904a provided according to an embodiment of the present invention is shown in FIG. 9B. In some embodiments, the pins 904a-c may be shaped so as to contact the lower major surface of the substrate S and extend above the top surface of the substrate S in the lift position (e.g., via shoulder 905a). Additionally or alternatively, the pins 904a-c may also have a profile (e.g., ramp, curve, etc.) that may assist in centering the substrate S when the pins 904a-c lift the substrate S. Although the pins 904a-c are shown as three substantially cylindrical shaped pieces, any suitable shape and quantity may be employed.

The drive motors 906a-b may be electric motors or other suitable mechanisms for rotating the drive rollers 602a-b, respectively. For example, the drive motors 906a-b may be direct drive electric motors that rotate the drive rollers 602a-b. Although two drive motors 906a-b are shown in FIG. 9A, fewer or more drive motors 906a-b may be employed. For example, a single driver motor may be employed that is coupled via a transmission (e.g., gears, belts, etc.) to the drive rollers 602a-b.

In operation, a substrate S may be loaded onto or unloaded from the third apparatus 600 as described above with reference to FIG. 6. The pins 904a-c may be in the lowered position when the substrate is loaded or unloaded from the third apparatus 600. For example, while the substrate S is in the internal region of the third apparatus 600, the substrate S may be supported by a robot as described with reference to FIGS. 4 and 6. Subsequently, the pins 904a-c may move to the lift position to lift the substrate S off the robot. The robot may then withdraw from the internal region of the third apparatus 600 while leaving the substrate S in the internal region of the third apparatus 600.

The pins 904a-c may be lowered to an intermediate position between the lifted and the lowered position as described above with reference to FIG. 8. While the substrate S is in the intermediate position, the idle rollers 604a-b may move towards the substrate S to press the substrate into the drive rollers 602a-b. Accordingly, the rollers 602a-b and 604a-b may hold and rotate the substrate S. Subsequently, the pins 904a-c may continue to a lowered position. The unloading of the substrate from the rollers 602a-b and 604a-b onto the pins 904a-c may be similarly accomplished.

FIG. 10 illustrates a top view of the third exemplary substrate cleaning apparatus 600 as provided according to an embodiment of the present invention. With respect to FIG. 10, the pins 904a-c are shown in contact with the substrate S. In the lowered position, the pins 904a-c do not extend past the top major surface of the substrate S.

The foregoing description discloses only exemplary embodiments of the invention. Modifications of the above disclosed apparatus and method which fall within the scope of the invention will be readily apparent to those of ordinary skill in the art. For instance, the present invention may employ megasonics to assist in substrate cleaning. Such megasonics (or other sonic energy) may be supplied directly to a major surface of the substrate S, or via sonicated fluid delivery. The housing(s) employed to enclose the cleaning apparatuses described above may accordingly be adapted to hold a volume of fluid without rapid leakage and possibly provide for full submersion of the substrate in one or more fluids, for example, during sonication.

Accordingly, while the present invention has been disclosed in connection with exemplary embodiments thereof, it should be understood that other embodiments may fall within the spirit and scope of the invention, as defined by the following claims.

The invention claimed is:

1. An apparatus for cleaning a substrate comprising:
a plurality of rollers adapted to contact and support the substrate in a horizontal orientation; and
at least one brush adapted to contact a major surface of the substrate while the substrate is supported by the plurality of rollers so as to clean the major surface of the substrate;
wherein at least one of the plurality of rollers is adapted to move between an opened position that allows the substrate to be loaded onto or unloaded from the plurality of rollers and a closed position in which the substrate is supported by the plurality of rollers.

2. The apparatus of claim 1, wherein at least one of the plurality of rollers is adapted to pivot between the opened and closed positions.

3. The apparatus of claim 1, wherein at least one of the plurality of rollers is adapted to move linearly between the opened and closed positions.

4. The apparatus of claim 1, wherein the at least one brush includes a first brush adapted to contact a first major surface of the substrate and a second brush adapted to contact a second major surface of the substrate while the substrate is supported by the plurality of rollers so as to clean the first and second major surfaces of the substrate.

5. The apparatus of claim 1, further comprising:
a plurality of pads adapted to support the substrate in a horizontal orientation when at least one of the plurality of rollers is in the opened position.

6. The apparatus of claim 5, wherein the plurality of pads are pivotable and adapted to move between a supporting position in which the plurality of pads are positioned beneath and in contact with the substrate and a non-supporting position.

7. The apparatus of claim 4, further comprising:
a first pivotable brush arm coupled to the first brush;
a second pivotable brush arm coupled to the second brush; and
a brush actuator coupled to the first and second pivotable brush arms;
wherein the brush actuator is adapted to pivot the first and second pivotable brush arms between a brush-opened position and a brush-closed position; and
wherein in the brush-closed position, the first and second brush arms pivot so as to press the first and second brushes onto the respective first and second major surfaces of the substrate.

8. The apparatus of claim 1, further comprising:
at least one fluid coupler adapted to provide a cleaning fluid to the at least one brush.

9. The apparatus of claim 1, wherein the plurality of rollers includes at least one driver roller and at least one idle roller.

10. The apparatus of claim 1, further comprising:
a lift arm movable between a lifted position and a lowered position; and
a lift actuator coupled to the lift arm and adapted to move the lift arm between the lifted and lowered positions;
wherein the lift arm is adapted to effect a lifting of the substrate in the lifted position.

11. The apparatus of claim 10, wherein the lift arm comprises a lift plate coupled to a plurality of lift pins.

12. The apparatus of claim 11, wherein the lift plate is adapted to lift the plurality of lift pins in the lifted position.

13. The apparatus of claim 11, wherein the lift pins are substantially cylindrical in shape and adapted to support the substrate in the lifted position.

14. The apparatus of claim 13, wherein the plurality of lift pins include a shoulder adapted to engage and support the substrate in the lifted position.

15. A method of cleaning a substrate comprising:
supporting the substrate in a horizontal position via a plurality of rollers; and
contacting at least one major surface of the substrate with a brush while the substrate is supported in the horizontal position so as to clean the major surface of the substrate.

16. The method of claim 15, further comprising:
moving at least one of the plurality of rollers from a closed position in which the plurality of rollers support the substrate to an opened position that allows the substrate to be loaded onto or unloaded from the plurality of rollers.

17. The method of claim 16, further comprising:
pivoting at least one of the plurality of rollers between the opened and the closed positions.

18. The method of claim 16, further comprising:
moving at least one of the plurality of rollers linearly between the opened and closed positions.

19. The method of claim 15, wherein contacting at least one major surface of the substrate with a brush comprises contacting a first major surface of the substrate with a first brush and contacting a second major surface of the substrate with a second brush while the substrate is supported by the plurality of rollers so as to clean the first and second major surfaces of the substrate.

20. The method of claim 16, further comprising:
providing additional support for the substrate in the horizontal orientation while at least one of the plurality of rollers is in the opened position.

21. The method of claim 20, further comprising:
positioning a plurality of pads beneath and in contact with the substrate to support the substrate in a horizontal orientation when at least one of the plurality of rollers is in the open position.

22. The method of claim 19, wherein contacting a first major surface of the substrate with a first brush and contacting a second major surface of the substrate with a second brush comprises:
pivoting the first brush toward the first major surface of the substrate; and
pivoting the second brush toward the second major surface of the substrate.

23. The method of claim 15, further comprising:
providing a cleaning fluid to the at least one brush.

24. The method of claim 15, further comprising:
moving the substrate vertically to a lifted position so as to allow a robot to engage and remove the substrate.

25. The method of claim 15, wherein the plurality of rollers are coupled to an edge of the substrate.
